(19) United States
(12) Patent Application Publication
(10) Pub. No.: US 2024/0161158 A1
(43) Pub. Date: May 16, 2024

(54) SERVICE PLAN AUTOMATIC GENERATION SYSTEM AND OPERATION METHOD THEREOF

(71) Applicants: Inventec (Pudong) Technology Corporation, Shanghai (CN); INVENTEC CORPORATION, Taipei (TW)

(72) Inventors: Yu-Lun Chang, Taipei (TW); Wei-Chao Chen, Taipei (TW); Chih-Pin Wei, Taipei (TW); Yao Yu Chung, Taipei (TW); Ying Chieh Kung, Taipei (TW); Yu Chang Chang, Taipei (TW)

(21) Appl. No.: 18/115,825

(22) Filed: Mar. 1, 2023

(30) Foreign Application Priority Data
Nov. 15, 2022 (CN) 202211427738.7

(51) Int. Cl. G06Q 30/0283

(52) U.S. Cl. CPC G06Q 30/0283

(57) ABSTRACT

The present disclosure proposes a service plan automatic generation system and operation method thereof. The operation method includes a method for generating standardized items based on a service record, which includes the following steps: analyzing multiple instances to generate multiple feature tags, generating multiple word frequency vectors corresponding to the feature tags according to the instances, and performing an aggregation procedure for a plurality of times. Each time performing the aggregation procedure includes: executing a clustering algorithm to divide multiple instances into multiple groups, analyzing multiple variable parts and an identical part of multiple feature vectors in each group, outputting the variable parts as feature tag sets, and using the identical part as an index of the group, when a stop condition is detected, the index generated by the aggregation procedure in the last time is outputted as a standardized item.

### CROSS-REFERENCE TO RELATED APPLICATIONS

This non-provisional application claims priority under 35 U.S.C. § 119(a) on Patent Application No(s). 202211427738.7 filed in China on Nov. 15, 2022, the entire contents of which are hereby incorporated by reference.

### BACKGROUND

### 1. Technical Field

The present disclosure relates to the request for quotation, data analysis, and artificial intelligence, and more particular to a service plan automatic generation system and operation method thereof.

### 2. Related Art

Every time when the clients issue a new service and request for quotation (RFQ), there would be a person in charge from the service provider to initiate an internal discussion accordingly. A service request normally demands for services such as design, production, or testing. The person in charge will pass them to several teams for evaluation. The related function teams will break down the request to many service items, and evaluate the resource capability accordingly. Resource consists of time, cost, personnel, equipment, an environment. Later on, the evaluations from all teams would feedback to the person in charge, gathering as a service plan quotation and reply to the client. The RFQ process is the business core, as a service plan quotation needs to be reliable and reasonable to the client, but also should be profitable for the service provider. Several pain points in current process are listed below:

First, time consuming. It is manually translated from business requirements into technical service items by various function teams, and then scheduled accordingly. This is very time-consuming as it requires many parties being looped in the discussion, which increases the complexity, and it might take a long time to respond to the clients;

Second, not standardized. Currently the process is heuristic, and the pricing is not standardized. As a result, the service quotation replied to clients often becomes challengeable, hard to explained, and prolonging the deal;

Third, lack of evaluation metric. At this point, there is no existing quantitative method to assess the proposed service plan, and consequently, no base line to see improvements either; and

Fourth, far from automation. The history and experience only compile in human brain so the process cannot be automated for future requests. Besides, some of the requests could be new to the system, without reference from the past.

### SUMMARY

Accordingly, the present disclosure proposed a system and method for generating a standardized service plan quotation automatically, limiting it to the least human effort, which saves time and cost.

According to an embodiment of the present disclosure, a method for generating a standardized item based on a service record, performed by a computing device and includes: analyzing a plurality of instances in the service record to generate a plurality of feature tags; generating a plurality of scores corresponding to the plurality of feature tags as a term frequency vector according to the plurality of instances; and performing an aggregation procedure for a plurality of times, wherein each time performing the aggregation procedure comprises: performing a clustering algorithm to classify a plurality of feature vectors corresponding to the plurality of instances into a plurality of groups, wherein each of the plurality of feature vectors comprises the term frequency vector; for each of the plurality of groups, analyzing a part of the plurality of feature vectors to obtain a plurality of variant parts and an identical part; outputting the plurality of variant parts as a feature tag set and using the identical part as an index of the group; and when detecting a stop condition of the aggregation procedure, storing the index generated last time by the aggregation procedure as the standardized item in an item database.

According to an embodiment of the present disclosure, a method generating a service plan based on a service request includes: performing the method for generating the standardized item based on the service record; receiving, by the computing device, the service request and selecting a plurality of candidate tags from the feature tag set; selecting, by the computing device, a plurality of recommended items from the item database according to the service request and the plurality of candidate tags; and scheduling, by the computing device, according to the plurality of recommended items and time information corresponding to the plurality of recommended items to generate a service plan.

According to an embodiment of the present disclosure, a service plan automatic generation system includes an item generator, an item selector, and a service scheduler. The item generator is configured to perform a plurality of steps to generate a plurality of feature tag sets and a plurality of standardized items according to a plurality of instances, wherein the plurality of steps includes: analyzing the plurality of instances to generate a plurality of feature tags; generating a plurality of scores corresponding to the plurality of feature tags according to the plurality of instances to serve as a term frequency vector; and performing an aggregation procedure for a plurality of times, wherein each time performing the aggregation procedure includes: performing a clustering algorithm to classify a plurality of feature vectors corresponding to the plurality of instances into a plurality of groups, wherein each of the plurality of feature vectors comprises the term frequency vector; for each of the plurality of group, analyzing the plurality of feature vector to obtain a plurality of variant parts and an identical part; outputting the plurality of variant parts as one of the plurality of feature tag sets and using the identical part as an index of the group; and when detecting a stop condition of the aggregation procedure, storing the index generated last time by the aggregation procedure as the standardized item in an item database. The item selector is configured to select a plurality of recommended items from the plurality of standardized items according to a service request and a plurality of candidate tags, wherein the plurality of candidate tags is selected from the plurality of feature tag sets. The service scheduler is configured to perform a scheduling to generate a service plan according to the plurality of recommended items and time information corresponding to the plurality of recommended item.

In view of the above, the method proposed by the present disclosure consults the historical service records from business inputs, and outputs recommended working items with resource requirements, such as the estimated duration, the required human resource, along with the service level. The service level is a reference index for the person in charge to easily adjust the service coverage. As a result, a service plan for quotation consists of working item list, schedule, and cost is prepared for quotation. In this way, any back-and-forth negotiation about the two key factors of project, the total cost and timeline, can be quickly rearranged. Hence, the system helps to settle down the deal, faster and more easily, which creates value for the customer as well. The improvements and benefits are as following:
First, standardized. The plan generated by the present disclosure is much more reasonable and reassured, as the working items are well defined based on past experience, which is clear and transparent for communicating with multiple concerning parties, including function teams and business clients;
Second, quantitative evaluation. A new reference index, service level, is calculated by the present disclosure, so the proposed plan has the flexibility to make trade-offs between resource consumption and service coverage; and
Third, automation. The process proposed by the present disclosure is in digitalized pipeline, which is time saving and increases the service agility.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of the first aspect of the design of the service plan automatic generation system according to an embodiment of the present disclosure;

FIG. 2 is a schematic diagram of the second aspect of the design of the service plan automatic generation system according to an embodiment of the present disclosure;

FIG. 3 is a flowchart of the method for generating standardized items based on service record according to an embodiment of the present disclosure;

FIG. 4 is a detailed flowchart of a step in FIG. 3; and

FIG. 5 is a flowchart of the method for generating a service plan based on a service request according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The present disclosure proposes a service plan automatic generation system, which is implemented by a computing device executing software. In an embodiment, the computing device may adopt one or more of the following examples: a personal computer, a network server, a microcontroller (MCU), an application processor (AP), a field programmable gate array (FPGA), an application specific integrated circuit (ASIC), a system-on-a-chip (SOC), a deep learning accelerator, or any electronic device with similar function, the present disclosure does not limit the type of hardware of the computing device. In addition, the present disclosure does not limit the number of computing devices. For example, each module of the software may be executed on an independent computing device, and the plurality of computing devices are communicably connected with each other.

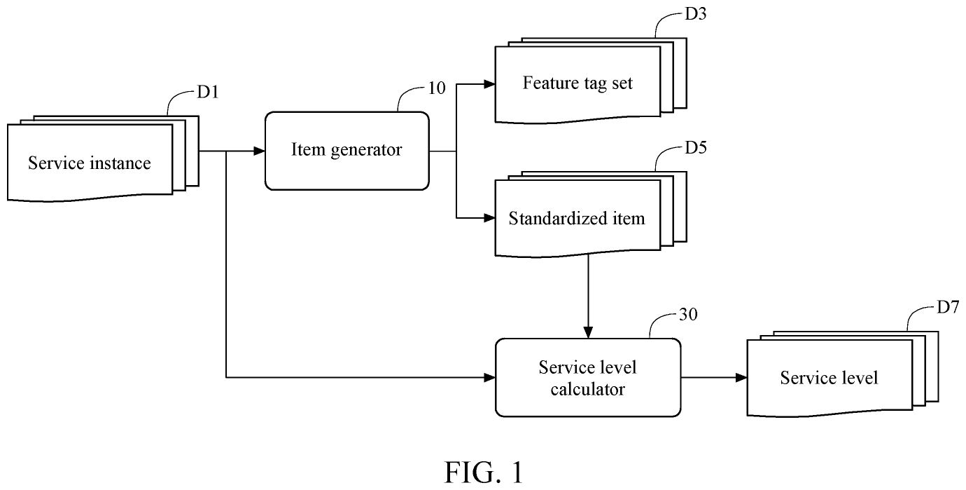

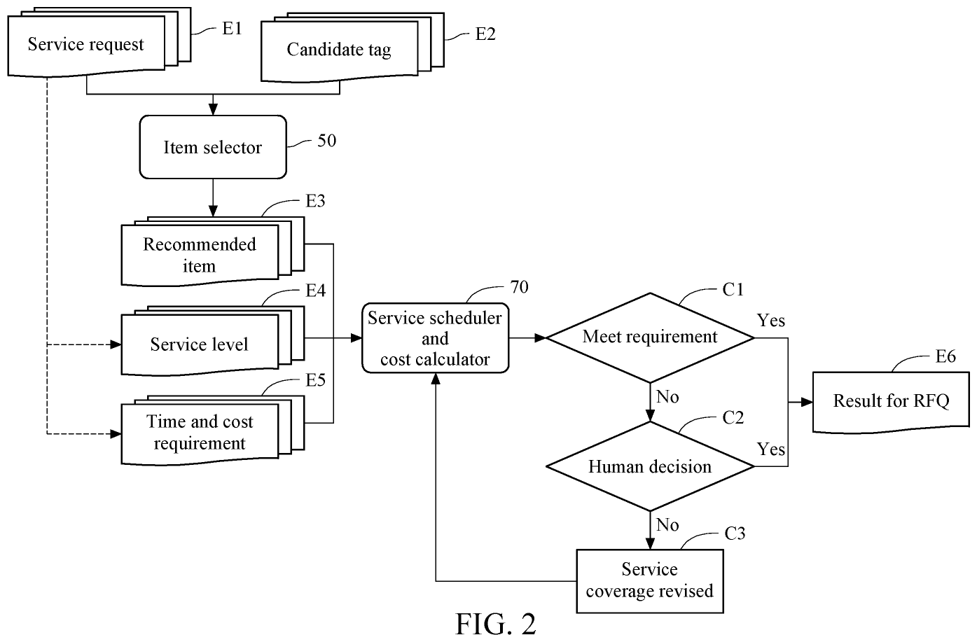

The design of the service plan automatic generation system is in two aspects: first, a standardized service item pool is generated from past experience with AI-supported module, with a small amount of human rectification. Second, the new service plan can be immediately created or revised in response to the client's requirements (service request). Both save considerable human efforts, time, and cost for business operation. Please refer to FIG. 1 and FIG. 2. FIG. 1 is a schematic diagram of the first aspect, and FIG. 2 is a schematic of the second aspect.

The proposed system includes an item generator and a service level calculator in the first aspect. The target of these two modules is to utilize the history for standardizing the service item. The item generator 10 includes two sub-modules (not shown in FIG. 1), a pre-processing module and a standardized item module.

Based on the service record (including a plurality of instances D1) as input, the pre-processing module included in the item generator 10 generates a plurality of feature dimensions. The plurality of feature dimensions includes text information (such as task description, hardware configuration), time information (such as date, duration, frequencies), risk information (such as status of failed or passed, difficulty level), associated items, and so on.

Based on the pre-processed feature dimensions, the standardized item module included in the item generator 10 sets up a distance matrix, and the service record may be further integrated or regrouped with unsupervised clustering algorithms, generating a plurality of feature tag sets D3 and a plurality of standardized items. The calculation of the distance matrix may be selected such as Jaccard similarity coefficient, cosine similarity or any calculation of similarity according to usage scenarios.

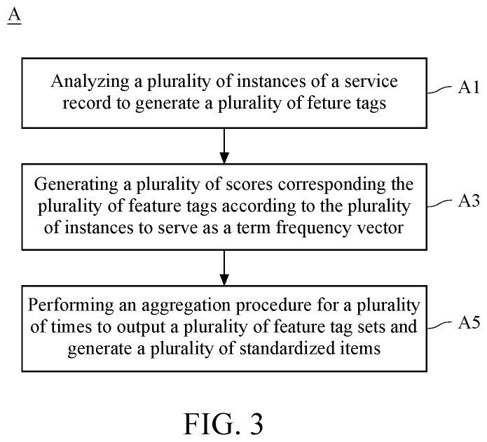

As shown in FIG. 1, the item generator 10 generates feature tag sets D3 and standardized items D5 according to the plurality of instances D1. Specifically, the item generator 10 performs a method for generating standardized service items based on service records, and the flowchart of this method is shown in FIG. 3. FIG. 3 includes steps A1 to A5 performed by the item generator 10 automatically. Please refer to FIG. 1 and FIG. 3 for the following descriptions.

In step A1, the pre-processing module included in the item generator 10 analyzes a plurality of instances of a service record to generate a plurality of feature tags. In an embodiment, the pre-processing module uses the stemming technique.

For better understanding, the same application scenario is adopted in the following description, and the technical details are described for each step and module. Table 1 and Table 2 below correspond to the input (service record) and output (feature tag) of the pre-processing module respectively. As shown in Table 1, the service record includes the plurality of instances D1 and their serial numbers. For the sake of brevity, Table 1 only shows the instance name. In an embodiment, in addition to the instance name, an instance may also include a large amount of information such as the production steps of the instance, the time and cost required for each step, the probability of production failure, and the equipment required for production. It should be noted that the instance in the service record may have wrong information, for example: instance 12 is actually the same as instance 1, but the name of instance 12 is misspelled. This situation will be rectified by human in a later step.

Table 1, an example of service record.

| No. | Instance name |
|---|---|
| 1 | banana ice cream |
| 2 | blueberry ice cream |
| 3 | cherry ice cream |
| 4 | chocolate pound cake |
| 5 | banana pound cake |
| 6 | pikachu birthday cake |
| 7 | chocolate birthday cake |
| 8 | strawberry birthday cake |
| 9 | chocolate milkshake |
| 10 | strawberry milkshake |
| 11 | banana milkshake |
| 12 | bannana ice cream |
| . . . | . . . |

Table 2, an example of feature tag.

| ID | Feature tag |
|---|---|
| 1 | banana |
| 2 | birthday |
| 3 | blueberry |
| 4 | cake |
| 5 | cherry |
| 6 | chocolate |
| 7 | cream |
| 8 | ice |
| 9 | lemon |
| 10 | milkshake |
| 11 | pound |
| 12 | strawberry |
| 13 | bannana |
| . . . | . . . |

In step A3, the standardized item module generates a plurality of scores corresponding the plurality of feature tags according to the plurality of instances to serve as a term frequency vector. In an embodiment, the score is calculated by a term frequency (TF) and/or a term frequency-inverse document frequency (tf-idf). The execution result of step A3 using TF is shown in Table 3, where the unfilled field represent a zero value. Please refer to Table 1 and Table 2. The instance “banana ice cream” with No. 1 corresponds feature tags with No. 1, No. 6, and No. 8. Therefore, in Table 3, the term frequency vector of instance No. 1 is [1 0 0 0 0 0 1 1 . . . ]. It should be noted that using TF and tf-idf for the same instance will produce different term frequency vectors. The range of values in the term frequency vector may be 0/1 or any real numbers, and this depends on the calculation method of the score. In general, the higher the score is, the more representative the feature tag is.

Table 3, an example of the term frequency vector.

TABLE 3
an example of the term frequency vector.

| | ID | | | | | | | | |
|---|---|---|---|---|---|---|---|---|---|
| No. | 1 | 2 | 3 | 4 | 5 | 6 | 7 | 8 | . . . |
| 1 | 1 | | | | | | 1 | 1 | . . . |
| 2 | | | 1 | | | | 1 | 1 | . . . |
| 3 | | | | | 1 | | 1 | 1 | . . . |
| 4 | | | | 1 | | 1 | | | . . . |
| . . . | . . . | . . . | . . . | . . . | . . . | . . . | . . . | . . . | . . . |
| N | . . . | . . . | . . . | . . . | . . . | . . . | . . . | . . . | . . . |

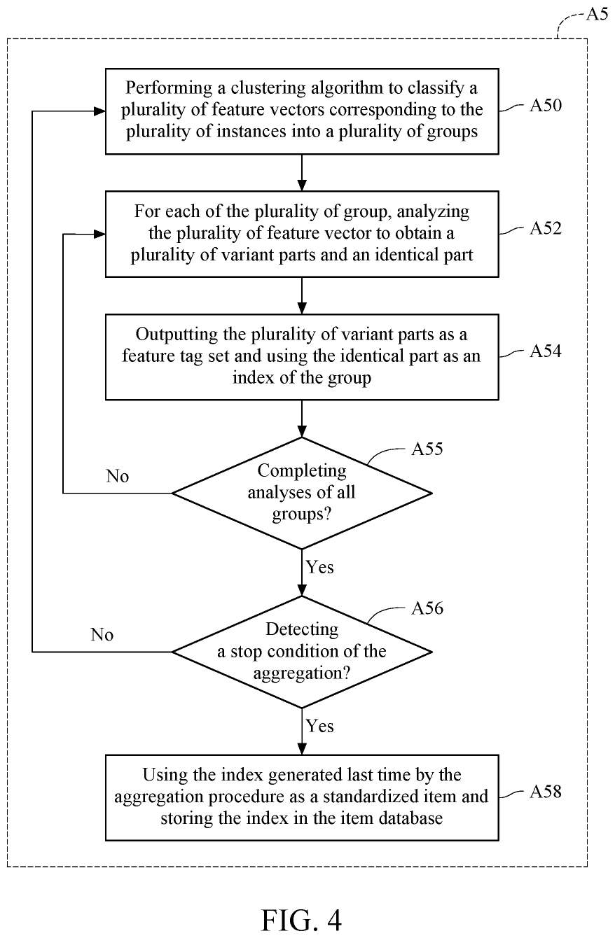

In step A5, the standardized item module performs an aggregation procedure for a plurality of times to output one or more feature tag sets and generate a plurality of standardized items. FIG. 4 is a detailed flowchart of the aggregation procedure. Specifically, the standardized item module executed multiple aggregation procedures, and each aggregation procedure includes steps A50 to A58 shown in FIG. 4.

In step A50, the standardized item module performs a clustering algorithm to classify a plurality of feature vectors corresponding to the plurality of instances into a plurality of groups. Each feature vector has a plurality of feature dimensions, which includes the term frequency vector at least. In an embodiment, the feature vector further includes time information, risk information, and other information as shown in the following Table 4. The time information, risk information and other information may be converted into a numerical vector form using a specified conversion mechanism or according to the distribution state. For example: “Friday, Oct. 21, 2022” can be converted to a 19-dimensional vector of [0000100, 000000000100]. The conversion mechanism of this vector is: The seven numbers on the left correspond to Monday to Sunday (because the example is Friday, the first from the left five values are 1, and the rest are 0), and the twelve values on the right correspond to January to December (because the example is October, the third last value is 1, and the rest are 0).

Table 4, an example of the feature vector.

TABLE 4
an example of the feature vector.

| | Feature vector | | | |
|---|---|---|---|---|
| | Term | Time | Risk | Other |
| No. | frequency vector | Info. | Info. | Info. |
| 1 | | | | |
| 2 | | | | |
| 3 | | | | |
| 4 | | | | |
| . . . | | | | |

In an embodiment, the clustering algorithm is hierarchical clustering. Table 5 is a grouping example of the execution result of step A50. For the sake of simplicity, only the term frequency vector of the feature vector is presented, and the value in the vector is replaced by the instance name to be easily understood.

Table 5, grouping example.

| | Feature vector | | |
|---|---|---|---|
| No. | Variant part | Identical part | Group ID |
| 1 | banana | ice cream | 1 |
| 2 | blueberry | ice cream | |
| 3 | cherry | ice cream | |
| 12 | bannana | ice cream | |
| 4 | chocolate | pound cake | 2 |
| 5 | banana | pound cake | |
| 6 | pikachu | birthday cake | 3 |
| 7 | chocolate | birthday cake | |
| 8 | strawberry | birthday cake | |
| 9 | chocolate | milkshake | 4 |
| 10 | strawberry | milkshake | |
| 11 | banana | milkshake | |
| . . . | . . . | . . . | . . . |

In step A52, the standardized item module extracts a plurality of feature vectors in a group, and analyzes a plurality of variant parts and an identical part of these feature vector. Taking the example in Table 5, the four feature vectors (corresponding to instances 1, 2, 3, and 12 respectively) of group 1 are extracted first. In an embodiment, the standardized item module adopts Natural Language Processing (NLP) technology in artificial intelligence to analyze the same dimension (ice cream) in these feature vectors as the identical part, and different dimensions (banana, blueberry, cherry, banana) of these feature vectors as the plurality of variant parts.

In step A54, the standardized item module outputs the variant parts as feature tag sets, and uses the identical part as an index of the group. Continuing from the above example, the feature tag set outputted first includes four tags, “banana, blueberry, cherry, banana”. The index of group 1 is “ice cream”. The index makes it easy to understand the attribute of the group. In an embodiment, the longest identical phrase in the identical part may be used as a group name that is easily recognizable by humans. If the text part is missing, it can be named manually. In an embodiment, the system administrator reviews each feature tag output by the system, and removes or corrects wrong tags, such as removing the tag “banana” or correcting it to “banana”.

In step A55, the standardized item module determines whether analyses of all groups are completed. If the determination is “yes”, step A56 will be performed. If the determination is “no”, the next step will be step A52 for selecting another group to repeat the process of steps A52 to A55.

In step A56, the standardized item module determines whether to detect a stop condition of the aggregation procedure. If the determination is “yes”, step A58 will be performed. If the determination is “no”, the next step will be step A50 for regrouping the current groups. Each regrouping may reduce the number of groups. In an embodiment, the stop condition is that the number of groups is less than a threshold, such as 100 groups or the similarity between groups is less than another threshold such as 0.6.

In step A58, the standardized item module stores the index generated by the aggregation procedure last time as the standardized item D5 in the item database. For example, regarding group 2 (pound cake) and group 3 (birthday cake) in Table 5, these instances in group 2 and group 3 may be classified into the same large group after executing the aggregation procedure multiple times, and may use “cake” as the standardized item D5.

It should be noted that common NLP only focuses on the analysis of the identical part, so after the identical part is obtained, the original feature vector is no longer processed. On the other hand, the present disclosure not only extracts the identical part in the feature vector, but also extracts the variant part as the feature tag set to output. Therefore, the present disclosure is different from common NLP, as shown in step A5 of FIG. 3 and the flowchart of FIG. 4. As shown in FIG. 4, the present disclosure regroups the feature vector multiple times to output the feature tag set D3 in each grouping process, and output standardized item D5 according to the final grouping result.

Please refer to FIG. 1. The service level calculator 30 generates a plurality of service levels according to the plurality of instances D1. Specifically, the service level calculator 30 quantifies the provided standardized item D5 by combining several indices regarding the risk, difficulty, importance, resource consumption, and so on. In an embodiment, the service level is calculated as following:

Lᵢ=β₀+β₁Xᵢ₁+β₂Xᵢ₂+ . . . +βₚXᵢₚ (Equation 1),

where Lᵢ denotes the i^{th} service level of the standardized item D5, X denotes related indices, p denotes the number of indices, and β denotes the weight.

In an embodiment, one of the related indices X that compose the service level Lᵢ is the adjusted failure rate. Specifically, the service level calculator 30 calculates the predicted failure rate based on each historical record (instance D1) and Bayesian Inference as follows:

$${F}_{adjusted} = \frac{{N}_{conf} \times {F}_{mean} + {N}_{item} \times {F}_{item}}{{N}_{conf} + {N}_{item}} , \qquad ( Equation 2 )$$

where F_{adjusted} denotes the adjusted failure rate, which is a weighted sum of Fₘₑₐₙ and Fᵢₜₑₘ, Fₘₑₐₙ is the failure rate in general, Fₘₑₐₙ is the failure rate of any specific standardized item D5. For the weights, Nᵢₜₑₘ is the number of executions for the specific standardized item D5, and N_{conf} is the number of historical executions of the specific standardized item D5 with credibility.

Overall, the service level calculator 30 performs the following steps: analyzing a plurality of instance D1 to find out a specific failure rate Fᵢₜₑₘ corresponding to the standardized item D5, calculating the average failure rate Fₘₑₐₙ according to the instance D1, and calculating the failure weighted sum

$$\frac{{N}_{conf} \times {F}_{mean} + {N}_{item} \times {F}_{item}}{{N}_{conf} + {N}_{item}}$$

as the adjusted failure rate F_{adjusted} according to a product N_{conf}×Fₘₑₐₙ of the confidence index N_{conf} and the average failure rate Fₘₑₐₙ, and a product Nᵢₜₑₘ×Fᵢₜₑₘ of a number of execution of the standardized item D5 Nᵢₜₑₘ and the specific failure rate Fᵢₜₑₘ.

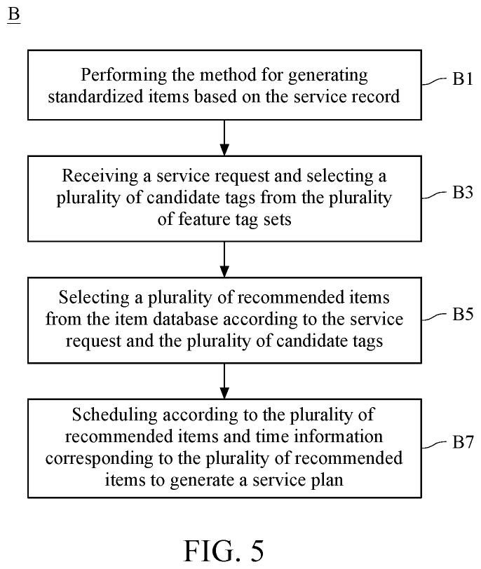

Please refer to FIG. 2 and FIG. 5. FIG. 5 is a flowchart of the method for generating a service plan based on a service request according to an embodiment of the present disclosure and includes steps B1, B3, B5, and B7. In step B1, the method for generating the standardized item based on the service record is performed, thereby generating the feature tag set D3 and the standardized item D5 according to the instances D1 as the historical record. In step B3, the item selector 50 receives the service request E1 and receives the plurality of candidate tag E2 selected from the feature tag set D3 by the user. In step B5, the item selector 30 selects the plurality of recommended item E3 from the item database to output according to the service request E1 and the candidate tag E2. In step B7, the service scheduler and the cost calculator 70 generate a service plan E6 according to the recommended item E3 and the plurality of requirements. In an embodiment, the plurality of requirements includes the service level requirement E4 and the time and cost requirement E5 shown in FIG. 2.

Overall, when a service request from the client is sent, a new service plan E6 may be created by using the service plan automatic generation system and the method for generating a service plan based on a service request proposed by the present disclosure. The service plan E6 includes a plurality of working items, each working item includes estimated resource consumption. In an embodiment, the service request E1 is a contract or document, whose text is, for example, as follows: “objective: a birthday party for a 10-year-old girl who likes the strawberry, with around 20 children (age from 8-10 year-old) and their parents, no peanuts and chocolate due to allergy issue”.

Given the detailed service request E1 and the candidate tag E2, the item selector 50 may automatically generate a plurality of recommended item E3 according to the item database storing a plurality of standardized items E5. In an embodiment, the client or the person in charge of providing service may manually select the candidate tag E2 or uses the system to automatically filters the candidate tags whose similarity exceeds the specified threshold from the feature tag set D3. Referring to the aforementioned scenario, the example of the feature tag set D3 and the candidate tag E2 is shown as Table 6 below, and the example of the standardized item D5 and the recommended item E3 is shown in Table below.

Table 6, an example of feature tag set and candidate tag, wherein blacks represent feature tags that are not specifically mentioned in the service request.

| Set No. | Tag No. | Feature tag | Candidate tag |
|---|---|---|---|
| 1 | 1 | banana | |
| | 2 | blueberry | Yes |
| | 3 | cherry | |
| | 4 | chocolate | No |
| | 5 | strawberry | Yes |
| 2 | 1 | pound | |
| | 2 | birthday | Yes |

Table 7, an example of the standardized items and the recommended items.

| No. | Standardized item | Recommended item |
|---|---|---|
| 1 | ice cream | |
| 2 | cake | Yes |
| 3 | milkshake | |
| . . . | . . . | . . . |

Next, the service scheduler 70 performs an automatic scheduling according to the standard execution time corresponding to the recommended items E3, and existing scheduling software can be used in practice. Following the above example, the output example of the service scheduler is shown in Table 8 below.

Table 8, an example of the output of the servicer scheduler.

TABLE 8
an example of the output of the service scheduler.

| | Standardized | | | | | | |
|---|---|---|---|---|---|---|---|
| No. | item | 10:00 | 11:00 | 12:00 | 13:00 | 14:00 | 15:00 |
| 2 | Cake | Step 1 | | | | Step 2 | |
| 31 | Juice | | | Order | | Pickup | |
| 44 | Chicken strips | | | | Step 1 | Step 2 | Step 3 |
| . . . | . . . | . . . | . . . | . . . | . . . | . . . | . . . |

Please refer to step C1 in FIG. 2, which determines that whether the requirement is met. The requirement includes, for example, the service level requirement E4 and time and cost requirement E5. In an embodiment, the service scheduler 70 further takes personnel, equipment, and environment constraint into account. If the determination of step C1 is “yes”, the service plan E6 including service scheduling and service cost will be directly outputted. The service cost is estimated by the cost calculator 70 according to the unit price. If the determination of step C1 is “no”, the next step will be step C2.

In step C2, it is judged manually whether it is necessary to adjust the standardized items D5 to be used in service plan E6. In other words, the scheduling results can be manually adjusted according to the requirements. For example, if it is found in the scheduling results that a certain standardized item E5 has a high failure rate, the estimated time during scheduling will be estimated to be longer. If the determination of step C2 is “yes”, the service plan E6 may be outputted directly. If the determination of step C2 is “no”, step C3 will be the next step for manually modifying the service coverage. Specifically, after the resource consumption (including time, personnel, etc.) is confirmed, the system checks whether the proposed service plan E6 meets the customer's requirements, including the two key factors of timeline and price. If not, the service coverage can be mitigated by cut-offs based on the service level ranking, or extended if some of the service items require higher maintenance from the clients. The modified service coverage is inputted into the service scheduler and cost calculator 70 to regenerate the schedule and cost.

In view of the above, the method proposed by the present disclosure consults the historical service records from business inputs, and outputs recommended working items with resource requirements, such as the estimated duration, the required human resource, along with the service level. The service level is a reference index for the person in charge to easily adjust the service coverage. As a result, a service plan for quotation consists of working item list, schedule, and cost is prepared for quotation. In this way, any back-and-forth negotiation about the two key factors of project, the total cost and timeline, can be quickly rearranged. Hence, the system helps to settle down the deal, faster and more easily, which creates value for the customer as well. The improvements and benefits are as following:

First, standardized. The plan generated by the present disclosure is much more reasonable and reassured, as the working items are well defined based on past experience, which is clear and transparent for communicating with multiple concerning parties, including function teams and business clients.

Second, quantitative evaluation. A new reference index, service level, is calculated by the present disclosure, so the proposed plan has the flexibility to make trade-offs between resource consumption and service coverage.

Third, automation. The process proposed by the present disclosure is in digitalized pipeline, which is time saving and increases the service agility.

What is claimed is:

1. A method for generating a standardized item based on a service record, performed by a computing device and comprising:
analyzing a plurality of instances in the service record to generate a plurality of feature tags;
generating a plurality of scores corresponding to the plurality of feature tags as a term frequency vector according to the plurality of instances; and
performing an aggregation procedure for a plurality of times, wherein each time performing the aggregation procedure comprises:
performing a clustering algorithm to classify a plurality of feature vectors corresponding to the plurality of instances into a plurality of groups, wherein each of the plurality of feature vectors comprises the term frequency vector;
for each of the plurality of groups, analyzing a part of the plurality of feature vectors to obtain a plurality of variant parts and an identical part;
outputting the plurality of variant parts as a feature tag set and using the identical part as an index of the group; and
when detecting a stop condition of the aggregation procedure, storing the index generated last time by the aggregation procedure as the standardized item in an item database.

2. The method for generating the standardized item based on the service record of claim 1, wherein the stop condition of the aggregation procedure is that a number of the plurality of groups is smaller than a threshold.

3. The method for generating the standardized item based on the service record of claim 1, further comprising:
analyzing the plurality of instances to calculate a specific failure rate corresponding to the standardized item;
calculating an average failure rate according to the plurality of instances; and
calculating a failure rate weighted sum of the standardized item according to a product of a confidence index and the average failure rate, and a product of a number of execution of the standardized item and the specific failure rate.

4. A method generating a service plan based on a service request comprising:
performing the method for generating the standardized item based on the service record of claim 1;
receiving, by the computing device, the service request and selecting a plurality of candidate tags from the feature tag set;
selecting, by the computing device, a plurality of recommended items from the item database according to the service request and the plurality of candidate tags; and
scheduling, by the computing device, according to the plurality of recommended items and time information corresponding to the plurality of recommended items to generate a service plan.

5. A service plan automatic generation system comprising:
an item generator configured to perform a plurality of steps to generate a plurality of feature tag sets and a plurality of standardized items according to a plurality of instances, wherein the plurality of steps comprises:
analyzing the plurality of instances to generate a plurality of feature tags;
generating a plurality of scores corresponding to the plurality of feature tags according to the plurality of instances to serve as a term frequency vector; and
performing an aggregation procedure for a plurality of times, wherein each time performing the aggregation procedure comprises:
performing a clustering algorithm to classify a plurality of feature vectors corresponding to the plurality of instances into a plurality of groups, wherein each of the plurality of feature vectors comprises the term frequency vector;
for each of the plurality of group, analyzing the plurality of feature vector to obtain a plurality of variant parts and an identical part;
outputting the plurality of variant parts as one of the plurality of feature tag sets and using the identical part as an index of the group; and
when detecting a stop condition of the aggregation procedure, storing the index generated last time by the aggregation procedure as the standardized item in an item database;
an item selector configured to select a plurality of recommended items from the plurality of standardized items according to a service request and a plurality of candidate tags, wherein the plurality of candidate tags is selected from the plurality of feature tag sets; and
a service scheduler configured to perform a scheduling to generate a service plan according to the plurality of recommended items and time information corresponding to the plurality of recommended item.

6. The service plan automatic generation system of claim 5, wherein the stop condition of the aggregation procedure is that a number of the plurality of groups is smaller than a threshold.

7. The service plan automatic generation system of claim 5, further comprising a service level calculator analyzing the plurality of instances to calculate a specific failure rate corresponding to the standardized item, calculating an average failure rate according to the plurality of instances, and calculating a failure rate weighted sum of the standardized item according to a product of a confidence index and the average failure rate, and a product of a number of execution of the standardized item and the specific failure rate.

8. The service plan automatic generation system of claim 5, wherein the service scheduler comprises a cost calculator calculating a cost of the service plan according to scheduling, the plurality of recommended items and a unit price corresponding to the plurality of recommended items.
